(19) United States
(12) Patent Application Publication
(10) Pub. No.: US 2019/0286171 A1
(43) Pub. Date: Sep. 19, 2019

(54) Flow Measurement In Valves With Thermal Correction

(71) Applicant: Siemens Aktiengesellschaft, Munchen (DE)

(72) Inventors: Martin Wetzel, Rastatt (DE); Mike Schmanau, Malsch (DE); Sven Oßwald, Fellbach (DE); Steffen Glöckle, Stutensee (DE)

(73) Assignee: Siemens Aktiengesellschaft, Munchen (DE)

(21) Appl. No.: 16/355,194

(22) Filed: Mar. 15, 2019

(30) Foreign Application Priority Data
Mar. 16, 2018 (EP) 18162331.5
Oct. 12, 2018 (EP) 18200063.8

(51) Int. Cl. G05D 7/06; G01F 1/36; G01F 15/00; G01F 22/02; F16K 37/00

(52) U.S. Cl. CPC G05D 7/0629; G01F 1/36; G05B 2219/37371; G01F 22/02; F16K 37/0083; G01F 15/005

(57) ABSTRACT

Various embodiments include a valve device comprising: a valve; a flow channel in the valve; a first sensor configured to record a first signal indicative of local fluid velocity in the flow channel; a second sensor configured to record a second signal indicative of a temperature of a fluid in the flow channel; and a control unit configured to determine a flow rate through the valve based on the first signal the second signal. The second sensor is moveably arranged in the flow channel.

### CROSS-REFERENCE TO RELATED APPLICATIONS

This application claims priority to EP Application No. 18200063.8 filed Oct. 12, 2018 and EP Application No. 18162331.5 filed Mar. 16, 2018, the contents of which are hereby incorporated by reference in their entirety.

### TECHNICAL FIELD

The present disclosure relates to valves. Various embodiments include methods for measuring a flow rate of a predetermined fluid through a valve and/or valve devices with a valve connectable to a pipe system.

### BACKGROUND

If a mass flow rate or volumetric flow rate through a pipe within a pipe system should be measured, in most cases a sensor is applied. This sensor is often only capable to measure a certain part of the fluid flow. This means that the sensor does not measure the overall flow rate through a pipe or a valve. It only measures a local quantity of the fluid flow within the pipe.

There exist several aspects that influence the measured quantity of the sensor. Therefore, the measured quantity of the sensor is usually not representative of the overall flow rate through the pipe. The following aspects for example influence the measured quantity of the sensor and the conversion of the measured quantity to the overall flow rate, respectively. The measured quantity of the sensor depends on the valve position or on the shape of the means that influence the flow rate through the valve. The flow pattern of the fluid flow at the position of the sensor also influences its measured quantity.

The measurement of the sensor also depends on the type of fluid or its degree of mutation. The pipe geometry upstream of the valve also has an influence on the measurement of the sensor. For example, a 90° pipe bend may change the flow pattern of the fluid flow. Furthermore, the temperature of the fluid also influences the measurement of the sensor.

The patent KR 101 702 960 B1 teaches a pressure control device and a pressure control method using the device. The document DE 103 05 889 B4 describes a valve. In particular this valve comprises one single sensor in order to measure a flow rate of the fluid within the valve.

The document EP 0 946 910 B2 describes a flow regulation fitting. This flow regulation fitting is able to adjust the flow rate through a pipe system. The flow regulation fitting device comprises a sensor that measures a quantity that is representative for the fluid flow rate through the valve. In particular, this sensor is arranged flatly on the fluid flow channel within the valve.

### SUMMARY

The teachings of this disclosure describe methods and valve devices able to measure the flow rate through the valve by considering at least one thermal aspect that influences the measurement of the at least one sensor. For example, some embodiments include a valve device (10) with a valve (12), the valve device (10) comprising: a flow channel (16) in the valve (12); a first sensor (18) configured to record at least one first signal indicative of local fluid velocity in the flow channel (16); a second sensor (20) configured to record at least one second signal indicative of a temperature of a fluid in the flow channel (16); and a control unit configured to determine a flow rate through the valve (12) based on the at least one first signal indicative of local fluid velocity and based on the at least one second signal recorded by the second sensor (20); characterized in that the second sensor (20) is moveably arranged in the flow channel (16).

In some embodiments, there is a third sensor (31) configured to record at least one third signal indicative of a valve position; and the control unit is configured to determine a flow rate through the valve (12) based on the at least one first signal indicative of local fluid velocity and based on the at least one second signal recorded by the second sensor (20) and based on the at least one third signal recorded by the third sensor (31).

In some embodiments, the third sensor (31) is moveably arranged in the flow channel (16).

In some embodiments, the second sensor (20) comprises a temperature sensor and the temperature sensor protrudes into the flow channel (16).

In some embodiments, the valve (12) comprises means to adjust the flow rate through the valve (12).

In some embodiments, the valve device (10) comprises a ball valve, a needle valve or a butterfly valve.

In some embodiments, the first sensor (18) comprises a temperature sensor and a heater; and the first sensor (18) is configured to record the at least one first signal indicative of local fluid velocity by applying a calorimetric measuring principle.

In some embodiments, the valve device (10) comprises a member to shape a flow pattern of a fluid flow in the flow channel (16).

### BRIEF DESCRIPTION OF THE DRAWINGS

This teachings herein are further described by the following figures. In these figures various examples are illustrated. It should be noted that these examples do not limit the scope of this disclosure. They only additionally describe the disclosure in order to give practical examples.

These figures show:

FIG. 1 a flow chart of an example method incorporating teachings of the present disclosure;

FIG. 2 a schematic principle of a valve incorporating the teachings of the present disclosure with a flow channel and an actuator in a cross-sectional view; and

FIG. 3 a schematic illustration of a flow channel with a valve and a thermal flow meter incorporating the teachings of the present disclosure.

### DETAILED DESCRIPTION

Various embodiments include a method for measuring a flow rate of a predetermined fluid through a valve by performing the following steps. In a step a) at least a local fluid velocity is measured in the valve. In some embodiments, this measuring is performed with a first sensor. For the next step two options b1) or b2) exist. In option b1) a temperature of the predetermined fluid in the valve is measured with a second sensor. Alternatively, in option b2) the temperature of the predetermined fluid is measured in the valve and a valve position of the valve is also measured. This means in both options b1) or b2) the temperature of the predetermined fluid is measured. In option b2) furthermore also a valve position of the valve is additionally measured. The temperature of the predetermined fluid may be measured in units of Kelvin.

In some embodiments, if a fluid has a temperature of 20° C., the first sensor measures a temperature of 293.15 Kelvin. The second sensor can measure the valve position of the valve in option b2). In particular the valve position of the valve describes an opening degree of the valve. The valve position can be for example a valve lift if the valve comprises a hub by which the flow rate through the valve can be influenced. If the valve is realised as a ball valve, the valve position can be described by the orientation of the ball with its hollow within the valve. Usually, a valve allows to adjust the flow rate within the valve. A very simple valve would be a shut-off valve. Such a valve may only allow for opening or shutting off completely. In this case the valve position would be 0% or 100%. An opening degree of 0% would mean that the valve blocks a fluid flow and therefore the flow rate is 0 m³/s. An opening degree of 100% means that the valve does not additionally reduce the fluid flow rate.

Most valves allow additional valve positions between the opening degrees of 0% and 100%. For example, a ball valve allows to adapt the flow rate of the fluid. For example, it is possible to reduce a flow rate of liquid water from 30 l/s to 10 l/s. In some embodiments, there are valves that allow to adjust different valve positions beside the extreme valve positions of 0% and 100%. The methods address such valves that allow at least one valve position between 0% and 100%.

In a step c) the flow rate through the valve is determined by considering the measured local fluid velocity in step a) and the measured parameters in steps b1) or b2). In some embodiments, an overall fluid flow rate through the valve is determined by considering the local fluid velocity on the one hand and at least one measured temperature of the predetermined fluid. In other words, the local fluid velocity that represents a part of the flow rate at the position of the first sensor is transformed into an overall quantity which is the flow rate through the valve. This can be achieved for example by a characteristic diagram. With such a characteristic diagram a fluid velocity profile over the cross section of a flow channel within the valve can be determined. Such a fluid velocity profile is in particular temperature-dependent and therefore by measuring the temperature of the fluid an additional information about the fluid flow can be gathered. This information can help to identify the flow pattern through the valve.

The temperature of the predetermined fluid has influence on the flow pattern of the fluid flow. For example, it is of great interest to classify the fluid flow through the valve into the categories turbulent or laminar flow. Therefore, additionally the temperature of the fluid in the valve may be useful. In some embodiments, an overall flow rate through a valve can be determined by measuring a local fluid velocity in the valve. Together with the measurements of one of the options b1) or b2) this local fluid velocity can be transformed or calculated into the overall flow rate through the valve. In other words, the local fluid velocity can be extrapolated to the overall flow rate through the valve by using the temperature of the predetermined fluid. It is not necessary to measure the amount of water that passes the valve within a period of time to calculate the flow rate through the valve. The principle of this disclosure enables an effective and accurate flow rate measurement of a fluid flow through a valve.

In some embodiments, there is a method, wherein a flow channel property, specifically a geometry or a roughness of a valve wall are additionally considered in step c) for determining the flow rate through the valve. The flow channel property, specifically a geometry or roughness of the valve wall are predetermined or these parameters can be measured by the first or the second sensor. These parameters can be considered by an appropriate equation, an additional coefficient in an equation or a characteristic diagram that includes the influences of these parameters. For example, an increased roughness of the valve wall leads to an increased friction induced by the valve. This causes a pressure drop that additionally may influence the flow rate of the fluid through the valve. The pressure drop induced by the valve is further influenced by the valve position of the valve, e.g. the valve lift of a hub in the valve. Nevertheless, the roughness of the valve wall has some influence on the flow rate of the fluid through the valve. In this variant of the disclosure this influence parameter is additionally considered. This argumentation is analogously true for the flow channel property specifically its geometry. By considering these additional parameters the determining of the flow rate through the valve may become more precise.

In some embodiments, a method, via the temperature of the predetermined fluid a density and/or viscosity of the fluid are determined and depending on the density and/or viscosity a fluid velocity profile is determined in order to determine the flow rate through the valve. The density and/or viscosity of a fluid flow may be important parameters that affect the flow pattern or a flow characteristic of the fluid flow through the valve. A change in the density of the fluid directly leads to a changed volume or a mass of the fluid flow rate. A modified viscosity directly influences the Reynolds number. The Reynolds number is a dimensionless number that is widely used in the fluid dynamics to classify different flow patterns. The Reynolds number contains as parameters a geometrical quantity that is in most cases a significant diameter, a mean value for the fluid velocity and the viscosity. In many cases by using the Reynolds number together with the properties of a flow channel a specific flow pattern can be determined. Different flow patterns may lead to different measured fluid velocities at the position of the first sensor.

For example, a fluid flow in a circular pipe is often described as laminar if the Reynolds number is less than 2300. If the Reynolds number is larger than 2300, a fluid flow within a circular pipe is often described as turbulent. These different flow patterns may have different fluid velocity distributions over the pipe cross section. Therefore, it is usually not sufficient to measure a local fluid velocity only at a single position within the pipe. To determine the flow rate through the valve precisely enough more information about the flow pattern through the valve is necessary.

In some embodiments, the density and/or viscosity of the fluid in the valve are determined and this additional information can be used to classify the specific flow pattern. Therefore, a measuring of the viscosity can help to capture or determine the fluid velocity profile along a cross section of a flow channel in the valve. With the knowledge of this fluid velocity profile in the valve the overall flow rate through the valve may be calculated more exactly originating from the local fluid velocity. The local fluid velocity in combination with the temperature and in this variant with the density and/or viscosity can be transformed into the flow rate of the valve. To do this, an appropriate characteristic diagram and/or adapted equation can be used for the flow rate determination. It is also possible that different flow patterns may be matched to appropriate flow rates. For example, in a look-up table several flow patterns in a specific geometry together with the local fluid velocities and their corresponding overall flow rates may be stored. In this case, the measured local fluid velocity and the determined flow pattern via the viscosity and/or density of the fluid directly leads to the overall flow rate through the valve. By additionally considering the density and/or viscosity the determining of flow rate through the valve may become more precisely.

In some embodiments, via the temperature a heat conductivity and/or heat capacity of the fluid are determined and depending on the heat capacity and/or heat conductivity a mutation of the fluid is registered for determining the flow rate in step c). A fluid may suffer from mutation. A mutation of the fluid may arise through ageing processes, chemical reactions, leakages, etc. This means that the fluid itself may change with time. For example, if the fluid is olive oil, it may become rancid after a certain time. It may be that the olive oil in the flow channel flocculates. The aim is not to determine the exact type of fluid present in the valve. It only aims to detect a change of the fluid beside the velocity or flow rate of the fluid.

A fluid may also suffer from mutation if for example a fluid comprises two different components and these two different components chemically react with each other. In this case, the chemical and physical properties of the fluid would change. By determining the heat conductivity and/or the heat capacity of the fluid such mutations or changes of the fluid may be detected. In particular, such mutations can be registered that do not arise from different flow rates or flow patterns. In particular, the heat conductivity and/or heat capacity of the fluid can be determined at several positions in the valve.

For example, if the fluid is liquid water that is heated up in a pipe system, a phase change significantly influences the fluid properties and therefore the measurement of the second sensor. If in this example at one position in the valve a heat conductivity of 0.6 W/(m K) is measured and at another position in the valve a heat conductivity of only 0.025 W/(m K) is registered, this can be a significant hint for a phase change of the water. In this situation it is probable that at the position where the lower heat conductivity has been measured gaseous water or at least non-condensable gases are present. A non-condensable gas may be air that degassed from the liquid water. In this situation these two significantly different values for the heat conductivity may indicate that a two-phase flow situation is present in the flow channel of the valve. Therefore, especially a flow characteristic for two-phase flows should be applied instead of a single-phase flow characteristic. If a flow rate determination is not exactly possible in case of a two-phase flow, at least the information can be extracted that the determined flow rate may be incorrect. In many pipe systems a phase change does not occur and therefore the measuring of the heat conductivity and/or heat capacity may be used as an indicator of a change in fluid properties.

If the fluid is in another example gasoline and some water enters into the pipe system due to leakages, a mixture of gasoline water is present in the pipe system and therefore also in the valve. This means the gasoline contains some impurities. A change in the heat conductivity and/or heat capacity of the fluid may indicate impurities of the fluid. In case of this example the water represents the impurity. If a significant amount of water contaminates the gasoline, a change in the heat conductivity and/or heat capacity of the gasoline is measurable. By measuring the heat conductivity and/or the heat capacity of the present fluid and comparing these values with standard values of the fluid without impurities a change of the fluid may be recognisable. This helps to supervise whether still the same fluid is present in the pipe system or in the valve. By considering the heat conductivity and/or the heat capacity of the fluid it can be avoided that the fluid drastically changes without being recognized. This means that this variant of the disclosure does not claim to identify the exact type of fluid in the valve, it only aims at recognizing significant changes of the fluid that are not induced by a changed flow rate or a changed flow pattern.

In some embodiments, the fluid velocity in step a) is measured by using a thermal flow meter as the first sensor. In this case the first sensor conducts temperature measurements in order to determine a local fluid velocity. In particular, the local fluid velocity is derived from a heat loss at the thermal flow meter. The heat loss at the thermal flow meter depends on the local fluid velocity. This means that a heat loss at the position of the thermal flow meter is determined and via this heat loss a local fluid velocity can be determined. Thermal mass flow meters are popular in industrial applications. Usually, they do not comprise any moving parts and therefore such flow meters are often attractive. In many cases such thermal flow meters do not require temperature or pressure corrections and they can cover a wide range of flow rates. A thermal flow meter usually does not induce a large pressure drop. Furthermore, a thermal flow meter can be designed in a very compact manner.

In some embodiments, at least one additional first sensor is applied in step a) to measure at least one additional local fluid velocity and an effective fluid velocity is calculated from the local fluid velocity and the at least one additional local fluid velocity to determine the flow rate through the valve. In this case several local fluid velocities are measured that may be average deviations in the measurements of the local fluid velocities. In particular, a mean value of the several local fluid velocities can be determined in order to achieve an effective fluid velocity. The several fluid velocities can be adapted by appropriate weighting factors. These weighting factors may include properties of the valves like the shape of the valve, the geometry of the flow channel etc. The several local fluid velocities may also address different volumetric parts of the flow channel in the valve. This means that each of the several first sensors can be matched to a certain volumetric part of the flow channel. The weighting factors can consider these different volumetric fractions. By considering several local fluid velocities and determining an effective fluid velocity from these several local fluid velocities the accuracy and stability of the flow rate determination can be improved or enhanced.

In some embodiments, the second sensor measures a fluid pressure and the flow rate through the valve is determined depending on the fluid pressure. Especially, in horizontal pipe systems a fluid pressure is the driving force of the flow rate. In particular the flow rate through the valve grows with increasing fluid pressure. The second sensor can be formed as a membrane sensor or as a piezo sensor. If the second sensor is formed as membrane sensor it can measure a differential fluid pressure. In most cases if the second sensor is formed as a pressure sensor, it provides a signal that is representative of the local fluid velocity. Usually this signal is formed as a Volt signal. With an appropriate equation and/or a correction factor this signal can be transformed into the local fluid velocity. This equation and/or the correction factor may further include the transformation to the overall flow rate through the valve. This means that the signal from the second sensor can either be transformed into the local fluid velocity or this signal from the second sensor can directly be transformed into the overall flow rate through the valve. This can be achieved by an appropriate characteristic diagram or by an appropriate equation. The equation and/or the characteristic diagram can be stored in a digital memory of the second sensor or an external control unit of the second sensor.

This principle is also valid if the second sensor measures a temperature of the fluid. By measuring the fluid pressure by the second sensor, information about a pressure distribution within the valve can be gathered. This additional pressure information can be useful in order to classify the actual flow pattern present in the valve. Therefore, a measurement of the pressure by the second sensor can help to identify the fluid velocity distribution in the flow channel of the valve. This means that this variant of the disclosure describes a further method to determine the flow profile or the fluid velocity distribution within the valve. By knowledge of the fluid velocity profile in the valve a more accurate determination of the overall flow rate is possible. In most cases a two-dimensional fluid velocity profile across a cross section of the valve is sufficient for determining the flow rate through the valve. In complex situations, it may be necessary to determine a three-dimensional fluid velocity distribution. In this case several second sensors may be necessary and applied. Advantageously, the second sensor is located at such position within the valve that a determination of a two-dimensional fluid velocity profile is sufficient.

In some embodiments, a valve device includes a valve connectable to a pipe. This valve device comprises a flow channel in the valve and a first sensor that is configured to measure a local fluid velocity in the flow channel. Furthermore, the valve device comprises a second sensor that is configured to measure the temperature of the fluid in the flow channel or the second sensor is configured to measure the temperature of the fluid in the flow channel and a valve position. This means there are two measuring options for the sensor. In the first option i) the second sensor measures only the temperature of the fluid in the flow channel, in the second option ii) the second sensor measures additional to the temperature of the fluid in the flow channel also the valve position of the valve.

In some embodiments, the valve device comprises a control unit that is configured to determine the flow rate through the rate by considering the measured local fluid velocity and the measured parameters in steps i) or ii). Mentionable is the fact that the valve device does not comprise a pipe system. It may actually be connected to a pipe system. This means that the measurements of the first and second sensor are conducted at or in the valve device. The control unit can be implemented into the first sensor or the second sensor. It is also possible that the control unit is not located at or in the valve. In this case the control unit preferably has a connection to the first sensor and the second sensor. For example, the first sensor and the second sensor may be connected to a computer terminal that receives the signals from the first sensor and second sensor. The connection of the first sensor or second sensor to the control unit can be wired or wireless. The described advantages in the different variants of this disclosure also apply to the valve device.

In some embodiments, the second sensor is configured as a temperature sensor and the temperature sensor protrudes into the flow channel of the valve. In some embodiments, the method includes considering temperature effects on the flow rate. A different fluid temperature in the valve affects the viscosity and therefore the Reynolds number of the fluid flow. This means that the temperature also affects the flow pattern in the flow channel. Therefore, the method may include measuring the temperature of the fluid within the valve. In general, this could also be achieved by the first sensor.

In some embodiments, the first sensor is optimized for measuring the local fluid velocity. This means that the type of the first sensor and its position within the valve is selected in such a way that the local fluid velocity can be measured effectively. In order to obtain information about the flow pattern in the valve, it may be necessary to measure the temperature of the fluid at another position than the position of the first sensor. Therefore, it may be useful that the second sensor is configured as a temperature sensor. In this case, the second sensor can be optimized with regard to temperature measurements. If the temperature sensor protrudes into the flow channel, the fluid temperature is measured rather than a temperature of the wall of the valve. This may reduce errors in the temperature measurements. The measured temperature of the second sensor may be more representative for the temperature of the fluid. This may improve the determination of the flow pattern in the flow channel of the valve. Finally, the determination of the fluid velocity profile in the flow channel and therefore the determination of the overall flow rate through the valve may be more accurate due to an improved fluid temperature measurement.

In some embodiments, the second sensor has such a protrusion into the flow channel of the valve that for two different predetermined flow patterns with the same flow rate for each one of the predetermined flow patterns the same flow rate for the valve is determined. One of the two different predetermined flow patterns may be defined as laminar flow and the other one as turbulent flow. These different flow patterns may be classified by two different Reynolds numbers. In both cases the second sensor has the same protrusion into the flow channel of the valve. Nevertheless, the final result of c) is the same in this situation. In case of the first flow pattern, for example the laminar flow, a first fluid velocity value and a first temperature value are measured. In case of the second flow pattern with the same flow rate, for example in this case the turbulent flow, a second local fluid velocity and a second temperature are measured.

Since the temperature may not be homogenous within the valve, the first temperature may differ from the second temperature. This means that in both cases the first sensor measures a first and second local fluid velocity in the flow channel of the valve. The second sensor, the temperature sensor, protrudes in both cases into the flow channel of the valve. The degree of protrusion is in both cases the same. For the first flow pattern a first fluid velocity and a first temperature are measured. For the second flow pattern a second temperature and a second local fluid velocity are measured. The degree of protrusion of the second sensor into the flow channel is set in such a way that in case of the same overall flow rate for both flow patterns the same flow rate is determined according to step c) of the disclosure. This degree of protrusion of the temperature sensor into the flow channel of the valve can be determined by considering fluid dynamics physics. This means that the valve device is sensitive to changes in the flow rate. It is less susceptible to changes in the flow pattern without a change in the flow rate through the valve. This can enhance the reliability of the flow rate determination.

In some embodiments, the second sensor is movably arranged in the flow channel of the valve. In some embodiments, this option is chosen if several different flow patterns in the flow channel of the valve can appear. This does not mean that two different flow patterns are present at the same time. A certain degree of protrusion of the second sensor into the flow channel of the valve may be optimal for a certain flow pattern. This degree of protrusion of the second sensor into the flow channel may further not be optimal with regard to other different flow patterns. Therefore, it is advantageous that the second sensor is movably arranged in the flow channel. This means the protrusion of the second sensor into the flow channel can be adapted.

For example, if the second sensor has a first degree of protrusion for a first flow pattern this first degree of protrusion may not be optimal if a second flow pattern occurs in the flow channel of the valve. This second flow pattern can be induced by changes of the flow rate or changes in the temperature. These changes usually lead to another flow pattern in the flow channel of the valve. In this situation it is possible that the first degree of protrusion of the second sensor into the flow channel of the valve is no longer optimal. Therefore, the second sensor is preferably movably arranged and the protrusion of the second sensor into the flow channel can be changed to a second degree of protrusion into the flow channel. Furthermore, not only the protrusion into the flow channel can be changed it is also possible that the position of the second sensor in the valve can be changed. This means that the position and/or the protrusion of the second sensor into the flow channel of the valve can be changed and adapted with regard to the flow pattern. Therefore more detailed information about the current flow pattern can be gathered. This can improve the determination of the flow rate through the valve since more accurate or more detailed information about the flow pattern in the flow channel of the valve can be gathered.

In some embodiments, the first sensor is located at a position in the flow channel, where a value of the local fluid velocity of a laminar flow is identical with the value of the local fluid velocity of the turbulent flow. In this variant the first sensor measures the same local fluid velocity for the laminar and turbulent flow. The different flow patterns can be considered by the measuring of the second sensor. This means that the measuring of the second sensor can result in two different flow patterns. The overall flow rate is determined depending on the measured quantities of the second sensor. In this case the measurement of the local fluid velocity by the first sensor does not suffer from a flow pattern change from laminar flow to turbulent flow or vice versa.

In some embodiments, the valve comprises means to adjust the flow rate through the valve. In particular, these means can increase or lower the friction to the fluid flow through the valve. This can directly change the flow rate through the valve. In particular, a lever or a hand gear can change the valve lift. A changed valve lift directly can change the opening degree of the valve. By modifying the valve lift the flow rate through the valve can be changed.

In some embodiments, the valve device is formed as a ball valve, needle valve or butterfly valve. In particular, a butterfly valve comprises a disc that can be rotated. Depending on the position of the disc in the valve relative to the wall of the valve different opening degrees can be adapted. A needle valve is often applied to relatively low flow rates. In particular, a needle valve comprises a small pot and a needle-shaped plunger. A ball valve is in particular a form of a quarter-turn valve which uses a ball with a bore that can be pivoted to control the valve lift and the flow rate through it. The ball valve is open when the ball's bore is in line with the flow channel. If the ball's bore is pivoted by 90 degrees it is completely closed. Depending on the position of the ball's bore different opening degrees of the ball valve can be realised.

In some embodiments, the first sensor comprises a temperature sensor and a heater and the first sensor is configured to measure the local fluid velocity by applying the calorimetric measuring principle. In particular, the first sensor is configured to measure a heat loss that is induced by the flow rate of the fluid flow. Different flow rates lead to different heat losses at the first sensor. This is because different flow rates induce different amounts of heat transfer. In particular, a larger flow rate induces a larger heat transfer. The heat loss or the heat transfer can be transformed into the flow rate by considering appropriate equations and/or characteristic diagrams.

In some embodiments, the valve device comprises a member to shape the flow pattern of the fluid flow in the flow channel of the valve. It is possible that the first or second sensor or both of them work optimally at certain flow patterns. Therefore, it can be useful to influence the flow pattern to the effect that the measurements conducted by the first and/or second sensor are optimized. Therefore, the valve device comprises a member to shape the flow pattern. A funnel can be such a member. The funnel can change the fluid velocity distribution in the flow channel of the valve. It may be possible that a funnel can change the flow pattern to a more directed flow pattern. The skilled person understands that the member to shape the flow pattern can be embodied by other objects. These objects could be a grid and/or a ball within the flow channel of the valve. By applying the member to shape the flow pattern, the measurements of the first and second sensor can additionally be optimized. This can lead to a very compact and effective valve device that can influence the flow rate and additionally measure the flow rate through the valve.

In some embodiments, the fluid is incompressible. The fluid flow can be for example a liquid water flow. If the fluid is incompressible like liquid water complex phenomena like gas compression or the like do not appear. This can simplify the flow rate determination or more basic sensors that may not be as expensive can be used.

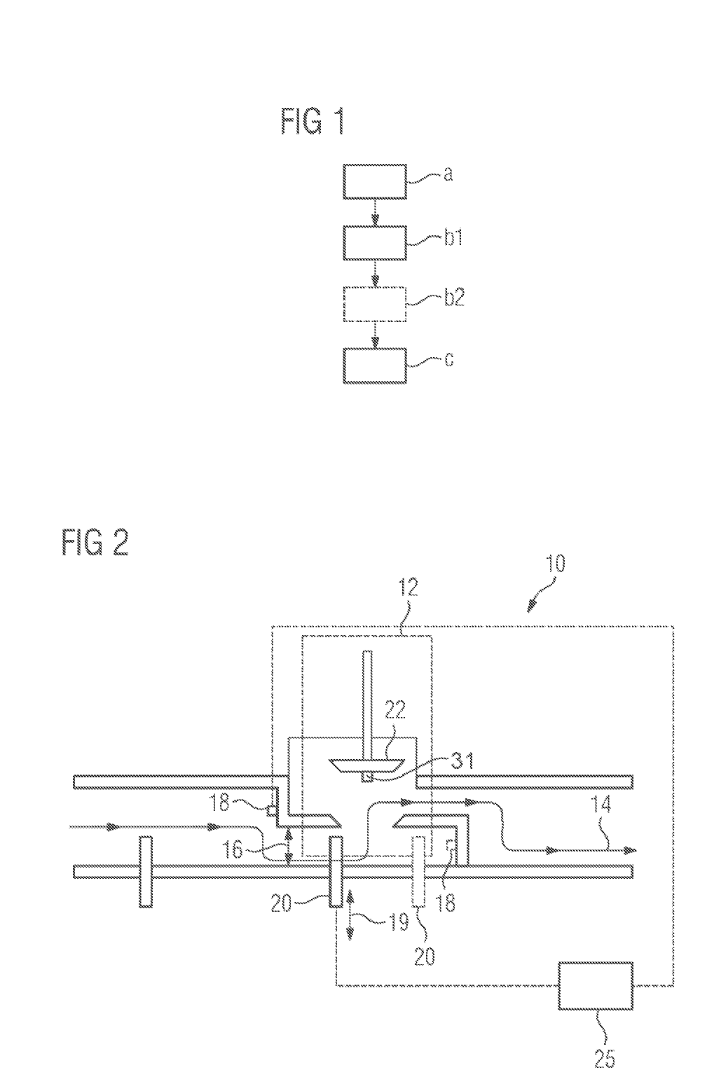

As illustrated in FIG. 1, the example method begins with a first step a). In the first step a) at least a local fluid velocity in the valve is measured. This may be performed by using a first sensor 18. The second step can be divided into two options. The first option of the second step b1 uses a second sensor 20 that measures a temperature of the pre-determined fluid in the valve. In option b2 the second option of the second step, a third sensor 31 measures additionally to the temperature of the fluid a valve position of a valve 12. In the third step c the flow rate through the valve 12 is determined depending on the measured local fluid velocity in step a) and the measured parameters in steps b1) or b2). The flow rate through the valve 12 can also be calculated by applying an appropriate characteristic diagram and/or an adequate equation. This equation can additionally comprise one or more correction factors that consider the circumstances of a current pipe system or the used valve 12.

In some embodiments, adjusting the flow rate and measuring the flow rate can be realized within a valve device 10 without a pipe system. Usually the flow rate is not measured at the position of the valve 12 or valve device 10. In order to get representative results, the measurement of the flow rate is often conducted at a pipe section before or after the valve 12. Such a pipe section can be referred to as a calming section where the turbulent effects induced by the valve 12 are not present and do not influence the measurement of the flow rate.

In some embodiments, there is no need for such a calming section. A calming section is often applied to get a representative quantity for the flow rate. In some embodiments, an inlet funnel or a flow rectifier into the calming section generates a load turbulent fluid flow. In some embodiments, a precise determination of the flow rate is still possible thanks to the combination of the first sensor 18 and the additional sensors 20, 31 and especially their synergetic effect for the flow rate determination. The measurement and adjustment of the flow rate can be realized by one single device. The presented valve device 10 does not need a calming section before or after the valve 12 in order to get representative quantities to determine the flow rate through the valve 12. Therefore, additional costs can be reduced. This means that changing the flow rate and measuring the flow rate through the valve 12 can be realised by one single valve device 10.

FIG. 2 shows an example valve device 10 that comprises a flow channel 16, the first sensor 18, the second sensor 20, and an actuator in the form of a plug in order to adjust the flow rate through the valve 12. The valve 12 is indicated by a dashed line in the middle of FIG. 2. A fluid flow direction 14 is indicated by small dashed arrows in FIG. 2. The first sensor 18 can measure at least a local fluid velocity in the flow channel 16 of the valve device 10. In this case, the flow channel 16 narrows within the valve device 10. The second sensor 20 can be positioned at different locations within the valve device 10. In this case the second sensor 20 is located at the bottom of the flow channel 16. In particular, the second sensor measures the temperature of the fluid in the flow channel 16. Furthermore, the second sensor can measure additional quantities. These additional quantities may refer to the position of the actuator 22 within the valve 12, a local geometry of the flow channel 16 in the valve device 10, the heat capacity or heat conductivity of the fluid in the flow channel 16.

In some embodiments, the second sensor 20 is also able to measure the type of the valve 12, the shape of the actuator 22, the run time of the valve 12 or a mixing ratio of the fluid that may be composed of several components. Usually, the type of the valve 12 and the type of fluid are predetermined. In many cases the second sensor 20 is focused on temperature measurements. Therefore, the second sensor 20 may comprise a temperature sensor. In FIG. 2, a third sensor 31 is shown at the bottom of the actuator 22. This third sensor 31 at the actuator 22 in FIG. 2 may not comprise a temperature sensor. The third sensor 31 at the actuator 22 measures the position of the actuator 22. This means this third sensor 31 can measure the valve lift or the opening degree of the valve 12.

As shown in FIG. 2, the sensors 20, 31 protrude into the flow channel 16 of the valve device 10. In some embodiments, the second sensor 20 is movably arranged and can be shifted along a sensor direction 19. Therefore, it is possible to measure not only a single temperature value, it is possible to measure a temperature profile along the cross section of the flow channel 16. This can help to classify the flow pattern present in the valve device 10.

In some embodiments, the first sensor 18 or the several first sensors 18 measure one or more local fluid velocities. This local fluid velocity is usually not representative for the flow rate through the valve. This is due to the fact that the fluid velocity profile along a cross section through the valve is not homogenous. Instead of measuring the local fluid velocity at several positions the local fluid velocity can be adapted by using the information gathered by the sensors 20, 31. By considering the information of the sensor(s) 20, 31 the overall flow rate through the valve device 10 can be determined. In particular, the temperature measurements of the second sensor 20 allow to derive a special flow pattern present in the valve device 10.

For example, by considering the information measured by the second sensor 20, a current flow pattern can be classified as a laminar flow. In another situation a turbulent flow situation can be determined by the second sensor 20. The fluid velocity profiles of a laminar flow and turbulent flow are usually different. The fluid velocity profile of a laminar flow often looks like a parable. This is often true for a laminar flow through a circular pipe. If the flow situation is turbulent the according fluid velocity profile may look significantly different. This information can be gathered by using the second sensor 20 and considering its measured information. In some embodiments, the first sensor 18 is positioned at a location were the fluid velocity for laminar flow is identical with the fluid velocity of a turbulent flow. In case of a straight circular pipe this position may be 0.7 times the radius of the pipe. In more complex situations for the valve device 10 an analysis can be performed beforehand to determine the best position for the first sensor 18. Such analysis can also be performed beforehand in order to determine the best position of the second sensor 20 and its degree of protrusion into the flow channel 16 of the valve device 10.

In some embodiments, the first sensor 18 and second sensor 20 have a wireless connection to a control unit 25. In the control unit 25 the information measured by the first and second sensor can be gathered and evaluated. Since the valve 12, the valve device 10, the geometry of the valve 12 and valve device 10 as well as the used fluid are usually predetermined, these pieces of information can already be available in the control unit 25. Therefore, the control unit 25 can consider a type of the valve 12 and other geometrical parameters like the shape or roughness of the flow channel 16 in the valve device 10.

In some embodiments, the control unit 25 conducts step c of this disclosure. This means that the first sensor 18 and the second sensor 20 can transmit their measured information to the control unit 25. The control unit 25 determines or calculates the flow rate through the valve 12. In the best case only one single first sensor 18 and one single second sensor 20 are necessary. In order to improve the reliability and stability of the flow rate measurement or flow rate determination several first sensors 18 or several second sensors 20 may be installed in the valve device 10.

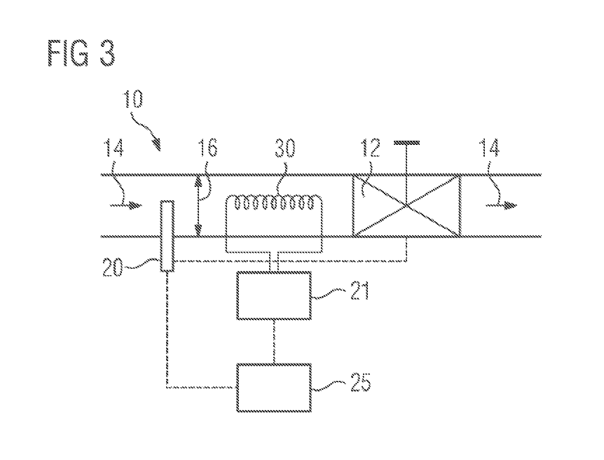

FIG. 3 shows an example embodiment of the teachings of this disclosure. FIG. 3 is a schematic picture of a thermal flow meter 30. In this case, the valve device 10 comprises a valve 12 and upstream of this valve 12 the thermal flow meter 30. In the flow channel 16 of the valve device 10 upstream of the thermal flow meter 30, the second sensor 20 is located. The flow direction 14 is indicated by arrows displayed in the flow channel 16. A temperature unit 21 connected to the thermal flow meter 30 is able to measure the local fluid velocity at the position of the thermal flow meter 30. Usually, this is done by measuring the heat loss that is induced at the heating section of the thermal flow meter. A higher heat loss indicates a higher local fluid velocity. The second sensor 20 and/or the thermal flow meter 30 can be included within the valve 12. For reasons of clarity, these components are separately shown in FIG. 3. The information of the second sensor 20 and the temperature unit 18 are gathered by the control unit 25. Together with static information like the geometry of the pipe system or the valve type the control unit 25 is able to determine the flow rate through the valve device 10 or the valve 12. If the fluid is incompressible the flow rate through the valve 12 is the same as the flow rate to the valve device 10.

The control unit 25 can also consider the flow profile at the inlet of the valve device 10. It also may consider a differential pressure between the inlet and outlet of the valve device 10. The influences induced by the flow profile at the inlet of the valve device 10 or the differential pressure over the valve 12 may be considered with regard to the determination of the flow rate through the valve 12. This may be performed by the control unit 25, wherein the control unit 25 may consider an appropriate characteristic diagram and/or characteristic equation.

In some embodiments, the second sensor 20 may also gather information about the position of the valve 12, especially the opening degree of the valve 12. This means that the second sensor 20 is not only able to measure the temperature of the fluid in the flow channel 16 of the valve device 10, it is also possible that the second sensor 20 can measure a valve position of the valve 12. This is indicated by a dashed line in FIG. 3 that connects the second sensor 20 with the valve 12. If the second sensor 20 is additionally able to measure the heat capacity and/or the heat conductivity of the fluid, additional information about the fluid condition can be gathered.

For example, it can be determined if the fluid suffered from ageing processes. This may be important for example in case of olive oil that can become rancid. Preferably, the second sensor 20 can gather this information and transmit it to the control unit 25. Therefore, the control unit 25 obtains more pieces of information and is able to determine the flow rate through the valve 12 more precisely. Preferably, the second sensor 20 is able to measure all parameters beside the local fluid velocity that influence the flow rate through the valve 12. To these parameters belong for example the temperature, the heat capacity, the heat conductivity, the valve position, and geometric parameters like the shape of the actuator 22 or the form and shape of the flow channel 16 within the valve device 10. This means that the second sensor 20 gathers additional information that allows a precise determination of the flow rate through the valve 12. The accuracy of determining the flow rate can be improved.

The valve device 10 can also be implemented into different pipe systems. Therefore, a modification of the control unit 25 can be sufficient. This means that static parameters like the used type of fluid or the pipe geometry can be entered as static information into the control unit 25. For example, this can be achieved by providing and transmitting an appropriate data input to the control unit 25.

In some embodiments, a more accurate or more precise measurement or determination of the flow rate through the valve 12 is possible. On the other hand, this measuring principle can be realized within a single unit, the valve device 10. Often used calming sections to provide a calm flow at the region of the flow rate measurement is no longer necessary. The valve device 10 may handle a complex flow situation within the valve device 10. However, the flow situation within the valve device 10 is more complex than it is for example in a long straight circular pipe, the flow rate through the valve device 10 can be determined more precisely only using the valve device 10. This means that a compact valve device 10 can be provided that additionally enables a more precise flow rate determination or flow rate measurement.

In some embodiments, the valve 12 is connectable to a pipe system or the valve 12 is connected to a pipe system. In some embodiments, the valve 12 is connectable to or is connected to a pipe system via a flange.

In some embodiments, the flow rate through the valve is a volumetric flow rate. In some embodiments, the flow rate through the valve is a mass flow rate. In some embodiments, the flow rate through the valve is a calorimetric flow rate.

In some embodiments, the valve 12 comprises the flow channel. In some embodiments, the valve 12 comprises a valve member. The valve member is selectively movable in an open position which enables fluid flow through the flow channel 16 and in a closed position which obturates fluid flow through the flow channel 16. The second sensor 20 is configured to record at least one second signal indicative of a temperature of a fluid in the flow channel 16 and of a position of the valve member.

In some embodiments, the control unit is configured to determine a flow rate through the flow channel 16.

The member to shape a flow pattern of a fluid flow may be selected from:
a spherical body;
a funnel;
a constriction;
a screen member;
an orifice; or
an aperture.

In some embodiments, the member to shape a flow pattern is arranged inside the flow channel 16. In another embodiment, the flow channel 16 comprises a port, the port being selected from an inlet or an outlet. The member to shape the flow pattern is arranged at or near the port of the flow channel 16.

As described in detail herein, the instant disclosure teaches a valve device 10 with a valve 12, the valve device 10 comprising
a flow channel 16 in the valve 12;
a first sensor 18 configured to record at least one first signal indicative of local fluid velocity in the flow channel 16;
a second sensor 20 configured to record at least one second signal indicative of a temperature of a fluid in the flow channel 16;
a control unit configured to determine a flow rate through the valve 12 based on the at least one first signal indicative of local fluid velocity and based on the at least one second signal recorded by the second sensor 20;
   characterized in that
the second sensor 20 is moveably arranged in the flow channel 16.

The instant disclosure also teaches a valve device 10 comprising:
a valve 12 and a flow channel 16 in the valve 12;
a first sensor 18 configured to record at least one first signal indicative of local fluid velocity in the flow channel 16;
a second sensor 20 configured to record at least one second signal indicative of a temperature of a fluid in the flow channel 16; and
a control unit configured to determine a flow rate through the valve 12 based on the at least one first signal indicative of local fluid velocity and based on the at least one second signal recorded by the second sensor 20;
   characterized in that
the second sensor 20 is moveably arranged in the flow channel 16 (in/of the valve 12).

The instant disclosure also teaches a valve device 10 comprising:
a valve 12; and
a flow channel 16 disposed in the valve 12;
a first sensor 18 configured to record at least one first signal indicative of local fluid velocity in the flow channel 16;
a second sensor 20 configured to record at least one second signal indicative of a temperature of a fluid in the flow channel 16; and
a control unit configured to determine a flow rate through the valve 12 based on the at least one first signal indicative of local fluid velocity and based on the at least one second signal recorded by the second sensor 20;
characterized in that the second sensor 20 is moveably arranged in the flow channel 16 (in/of the valve 12).

In some embodiments, the control unit is in operative communication with the first sensor 18 and with the second sensor 20. The control unit may be in operative communication with the third sensor 31. The second sensor 20 may be configured and/or arranged to be shifted along a sensor direction 19.

The instant disclosure also teaches any of the aforementioned valve devices 10, the valve device 10, and/or the valve 12 additionally comprising a third sensor 31 configured to record at least one third signal indicative of a valve position; and wherein the control unit is configured to determine a flow rate through the valve 12 based on the at least one first signal indicative of local fluid velocity and based on the at least one second signal recorded by the second sensor 20 and based on the at least one third signal recorded by the third sensor 31.

The valve 12 may comprise an actuator 22 and the third sensor 31 may be configured to record at least one third signal indicative of a position of the actuator 22. In some embodiments, the third sensor 31 is mounted to the actuator 22 and/or secured relative to the actuator 22. In some embodiments, the actuator 22 defines the valve position. In some embodiments, the third sensor 31 is configured to record at least one signal indicative of a valve position of the valve 12.

In some embodiments, the third sensor 31 is moveably arranged in the flow channel 16 (in/of the valve 12).

In some embodiments, the second sensor 20 comprises and/or is formed as a temperature sensor and the temperature sensor protrudes into the flow channel 16.

In some embodiments, the valve 12 comprises means to adjust the flow rate through the valve 12 and/or through the flow channel 16.

In some embodiments, the valve 12 comprises an actuator 22 to adjust the flow rate through the valve 12 and/or through the flow channel 16.

In some embodiments, the valve device 10 comprises and/or is formed as a ball valve, a needle valve or a butterfly valve.

In some embodiments, the valve device 10 comprises a ball valve and/or a needle valve and/or a butterfly valve.

In some embodiments, the valve 12 comprises and/or is formed as a ball valve, a needle valve or a butterfly valve.

In some embodiments, the first sensor 18 comprises a temperature sensor and a heater; and the first sensor 18 is configured to record the at least one first signal indicative of local fluid velocity by applying a calorimetric measuring principle.

In some embodiments, the valve device 10 comprises a member to shape a flow pattern of a fluid flow in the flow channel 16 of the valve 12.

In some embodiments, the valve device 10 comprises a funnel and/or a grid and/or a ball and/or an orifice to shape a flow pattern of a fluid flow in the flow channel 16.

In some embodiments, the valve 12 comprises a member to shape a flow pattern of a fluid flow in the flow channel 16.

In some embodiments, the valve 12 comprises a funnel and/or a grid and/or a ball and/or an orifice to shape a flow pattern of a fluid flow in the flow channel 16.

Parts of the valve device 10 or parts of a method according to the present disclosure may be embodied in hardware, in a software module executed by a processor, in a software module executed by a processor using operating-system-virtualization or by a cloud computer, or by a combination thereof. The software may include a firmware, a hardware driver run in the operating system, or an application program. Thus, the disclosure also relates to a computer program product for performing the operations presented herein. If implemented in software, the functions described may be stored as one or more instructions on a computer-readable medium. Some examples of storage media that may be used include random access memory (RAM), magnetic RAM, read only memory (ROM), flash memory, EPROM memory, EEPROM memory, registers, a hard disk, a removable disk, other optical disks, a Millipede® device, or any available media that can be accessed by a computer or any other IT equipment or appliance.

It should be understood that the foregoing relates only to certain embodiments of the disclosure and that numerous changes may be made therein without departing the scope of the disclosure as defined by the following claims. It should also be understood that the disclosure is not restricted to the illustrated embodiments and that various modifications can be made within the scope of the following claims.

### REFERENCE LIST

a first step
b1 first option of second step
b2 second option of second step
c third step
10 valve device
12 valve
14 flow direction
16 flow channel
18 first sensor
19 direction
20 second sensor
21 temperature unit
22 actuator
25 control unit
30 thermal flow meter
31 third sensor

1. A valve device comprising:
a valve;
a flow channel in the valve;
a first sensor configured to record a first signal indicative of local fluid velocity in the flow channel;
a second sensor configured to record a second signal indicative of a temperature of a fluid in the flow channel; and
a control unit configured to determine a flow rate through the valve based on the first signal the second signal;
wherein the second sensor is moveably arranged in the flow channel.

2. The valve device according to claim 1, further comprising a third sensor configured to record a third signal indicative of a valve position;
wherein the control unit is configured to determine a flow rate through the valve based on the first signal and the second signal and the third signal.

3. The valve device according to claim 2, wherein the third sensor is moveably arranged in the flow channel.

4. The valve device according to claim 1, wherein the second sensor comprises a temperature sensor protruding into the flow channel.

5. The valve device according to claim 1, wherein the valve comprises means to adjust the flow rate through the valve.

6. The valve device according to claim 1, wherein the valve device comprises at least one valve selected from the group consisting of: a ball valve, a needle valve, and a butterfly valve.

7. The valve device according to claim 1, wherein:
the first sensor comprises a temperature sensor and a heater; and
the first sensor is configured to record the first signal based on a calorimetric measuring principle.

8. The valve device according to claim 1, wherein the valve device comprises a member to shape a flow pattern of a fluid flow in the flow channel.
